(19) United States
(12) Patent Application Publication
(10) Pub. No.: US 2003/0152116 A1
(43) Pub. Date: Aug. 14, 2003

(54) Power-equalizing multi-channel fiber laser array

(76) Inventors: Hsien-Kuei Liao, Taoyuan Hsien (TW); Pie-Yau Chien, Panchiao City (TW); Hong-Yih Tseng, Hsinchu City (TW); Sien Chi, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/073,003

(22) Filed: Feb. 12, 2002

(51) Int. Cl. H01S 3/30

(52) U.S. Cl. 372/6

(57) ABSTRACT

The present invention provides a power-equalizing multi-channel fiber laser array, which comprises a pumping laser source, a 1×N ratio splitter, a plurality of WDM couplers, some pieces of EDFs, some pieces of fiber grating pairs, and a power-equalizing device (which may include variable optical attenuators). The power-equalization approach is realized by: (1) adding in some variable optical attenuators; (2) controlling the pumping power ratio to the individual channels by a 1×N variable ratio splitter; (3) adjusting the fiber lengths or the Er³⁺ concentration; or (4) adjusting the fiber gratings reflectivity.

### FIELD OF THE INVENTION

The present invention relates to a power-equalizing multi-channel fiber laser array.

### BACKGROUND OF THE INVENTION

For the selection of a multi-channel source, previous works presented a laser source consisting of individual semiconductor lasers, a semiconductor laser amplifier array, series-connected five distributed feedback laser arrays, and two comb filters used in a ring laser have been adopted. Research of dual-wavelength power-equalizing ring laser has also been made.

In response to abrupt expansion of information capacity, wavelength-division multiplexing technique has become the mainstream of high-capacity optical fiber transmission, wherein multi-channel laser sources for signal transmission are the key products. In this present invention, the erbium-doped fiber laser array has a specific amplification wavelength at 1550 nm band to totally match the band of signal amplification of the erbium-doped fiber amplifier. Under appropriate design of multi-channel fiber laser source, a pumping laser source can be used to save the cost. Simultaneously, each channel can be parallel connected to achieve the object of miniaturization. Because of the un-flattened gain shape of spontaneous emission of amplification of the erbium-doped fiber (EDF), after each channel of the multi-channel fiber laser lases, the output signal levels may be uneven, resulting in inequality of power level and signal to noise ratio (SNR) between signal wavelengths. This will deteriorate the quality of transmission. Therefore, it is necessary to make research of power equalization.

### SUMMARY OF THE INVENTION

The present invention makes use of parallel-connected pumping sources to manufacture a power-equalizing multi-channel fiber laser. Assume each section of erbium-doped fiber is of the same length with identical characteristic, and the input power from the pumping source is identical, the magnitude of power of the fiber laser will depend on the reflectivity of fiber gratings at two ends of the resonance cavity and the corresponding gain of the erbium-doped fiber at the lasing wavelength λ. Because the un-flattened characteristic of the amplified spontaneous emission (ASE) of erbium-doped fiber, this gain will be different at each wavelength (e.g., the gain at 1532 nm is larger than that at 1540 nm).

The present invention aims to propose four ways: (1) controlling the pumping power ratio by adding variable optical attenuators; (2) controlling the pumping power ratio by adjusting the pump ratio coupler; (3) adjusting the lengths of gain fibers or Er³⁺ concentration; and (4) adjusting the reflectivity of gratings; to manufacture a power-equalizing WDM laser source module having an architecture of parallel-connected power-splitting structure.

The various objects and advantages of the present invention will be more readily understood from the following detailed description when read in conjunction with the appended drawing, in which:

### BRIEF DESCRIPTION OF THE DRAWINGS

FIG. 1 is a spectrum diagram of a multi-channel fiber laser array of the present invention. (a) without power equalization, (2) with power equalization;

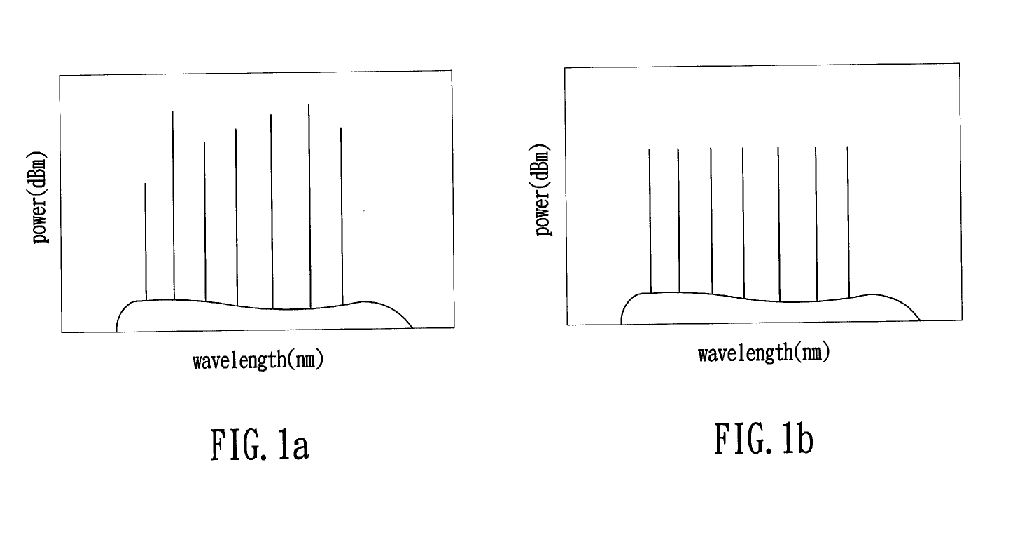

FIG. 2 is a block diagram according to an embodiment of the present invention;

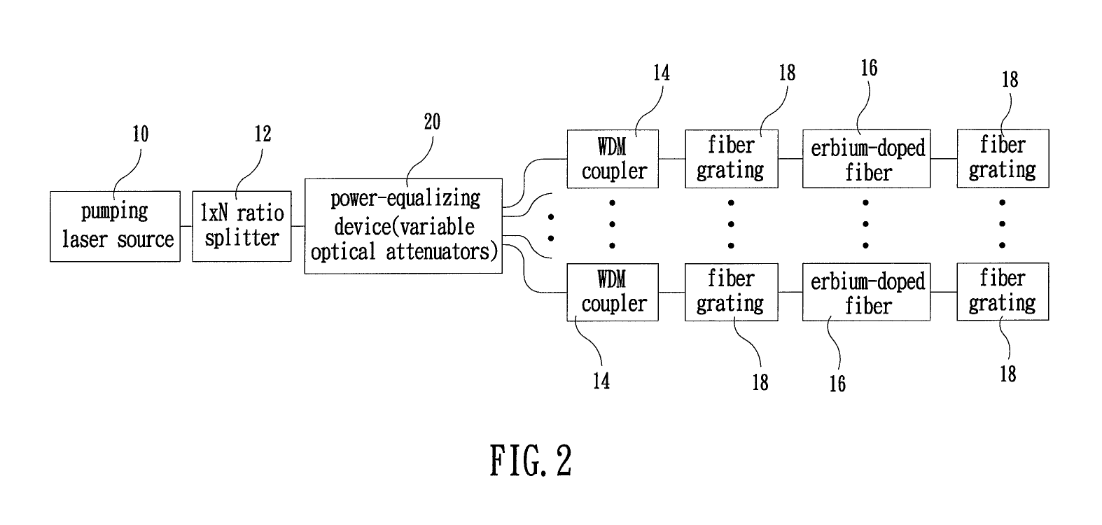

FIG. 3(a) shows a parallel-connected pumping power-splitting type fiber laser array architecture, wherein a plurality of variable optical attenuators (VOA) are added to control the pumping power for power equalization;

FIG. 3(b) shows a parallel-connected pumping power-splitting type fiber laser array architecture, wherein power equalization is controlled via a 1×N variable ratio splitter for power equalization;

FIG. 3(c) shows a parallel-connected pumping power-splitting type fiber laser array architecture, wherein the EDF length or the Er³⁺ doping concentration is controlled for power equalization; and

FIG. 3(d) shows a parallel-connected pumping power-splitting type fiber laser array architecture, wherein the reflectivity (Ri %) of the pair of gratings of the resonance cavity is controlled for power equalization. The reflectivity of both the fiber gratings are not necessarily equal.

### DETAILED DESCRIPTION OF THE PREFERRED EMBODIMENTS

The present invention discloses a power-equalizing multi-channel fiber laser array, which comprises a pumping laser source 10, a 1×N variable ratio splitter 12, a plurality of WDM couplers 14, N pieces of EDFs 16, a plurality of pairs of fiber gratings 18, and a power-equalizing deice 20 (in which may include variable optical attenuators or nothing). Laser light of the pumping source is coupled to the plurality of WDM couplers.

The fiber laser consists of fiber gratings having the same central wavelength of reflection placed at two ends of the erbium-doped fibers (EDFs) of a length of about several centimeters to several tens of centimeters. Therefore, optical signal can generate resonance wavelengths (i.e., Bragg wavelength) and lasing. The magnitude of power of wavelength depends on the pumping power, the EDF length (L), the Er³⁺ doping concentration, and the reflectivity (R₁R₂) of the pairs of grating reflectors. The optical power of the signal light after a round trip in the resonance cavity is:

P_{R}^{out}=ε²R²Pᵣ^{out}exp[−2αₛL+2P_{P}^{abs}/P_{S}^{CS}+2P_{S}^{abs}/P_{S}^{IS}]

wherein R²=R₁R₂, ε²=ε₁ε₂ (ε₁ and ε₂ are attenuations at two ends in the cavity), αₛ is the absorption coefficient of the EDF at the laser wavelength, P_{P}^{abs} and P_{S}^{abs} are absorbed powers of the pumping light and the signal light after a round trip in the EDF, and the P_{S}^{CS} and P_{S}^{IS} are characteristic parameters of the EDF. The total output laser power after many times of round trips in the resonance cavity is:

P_{Las}=(1−R²)ε²Pᵣ^{out}

The above principle is applied to the practical architecture. In the present invention, N-channel fiber lasers are parallel connected, and an appropriate coupler or splitter is used to guide the pumping laser light into the fibers. To ensure the quality of WDM transmission, the problem of uneven power between channels needs to be resolved. In consideration of influences of the parameters like the pumping power and the grating reflectivity to the power of each channel, optimal design and analysis of parameters are made. Because the laser output power depends on many parameters, the calculation is very complicated. In order to resolve the above problem, a reverse calculation method is adopted. In other words, the unmodified output result of the WDM light sources are first found out (light signal levels between channels may be unequal), and the pumping power ratio, the EDF length, the Er³⁺ concentration, or the grating reflectivity is then adjusted one by one to equalize the powers among channels. Of course, the above parameters can also be jointly adjusted. Commercial specifications (e.g., the grating reflectivity) can be defined by matching experimental or theoretical data and letting the manufacturing conditions be the same each time.

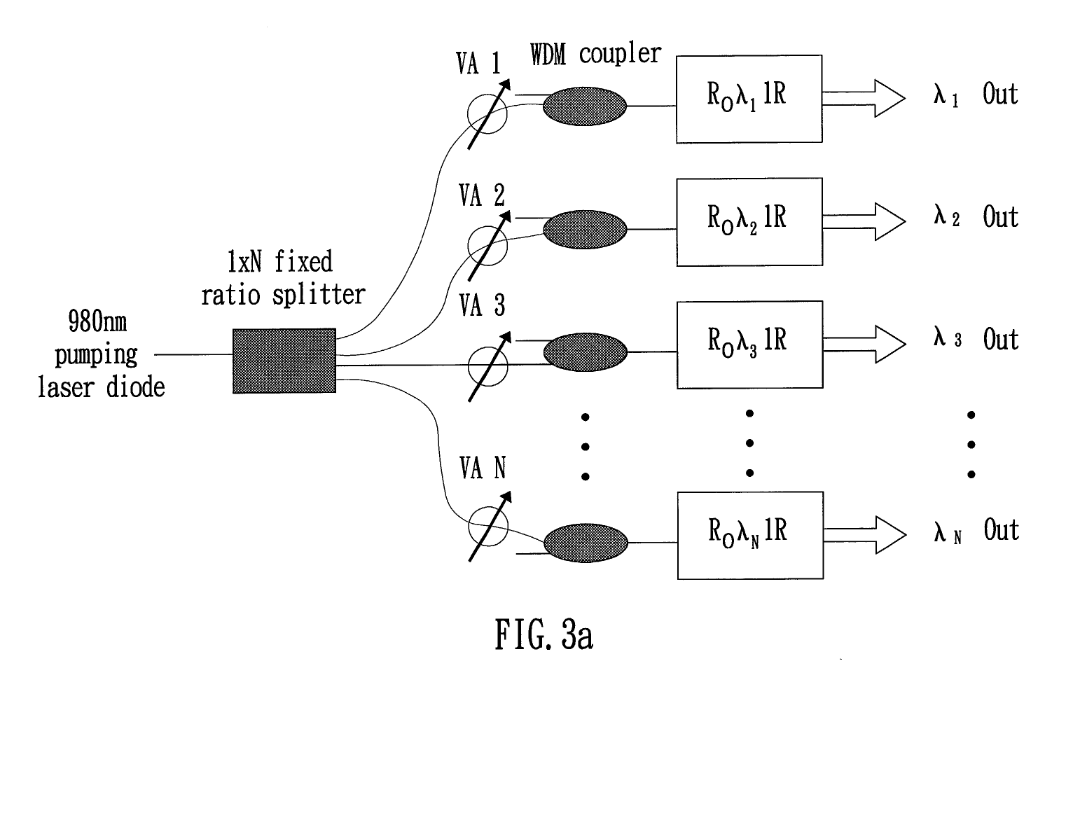

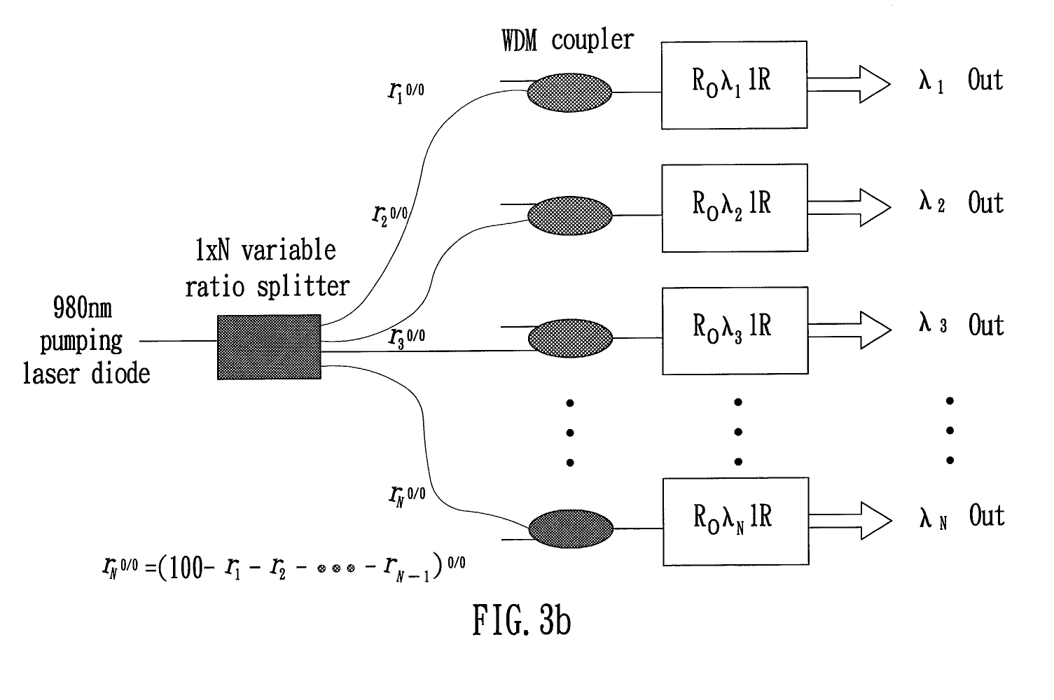

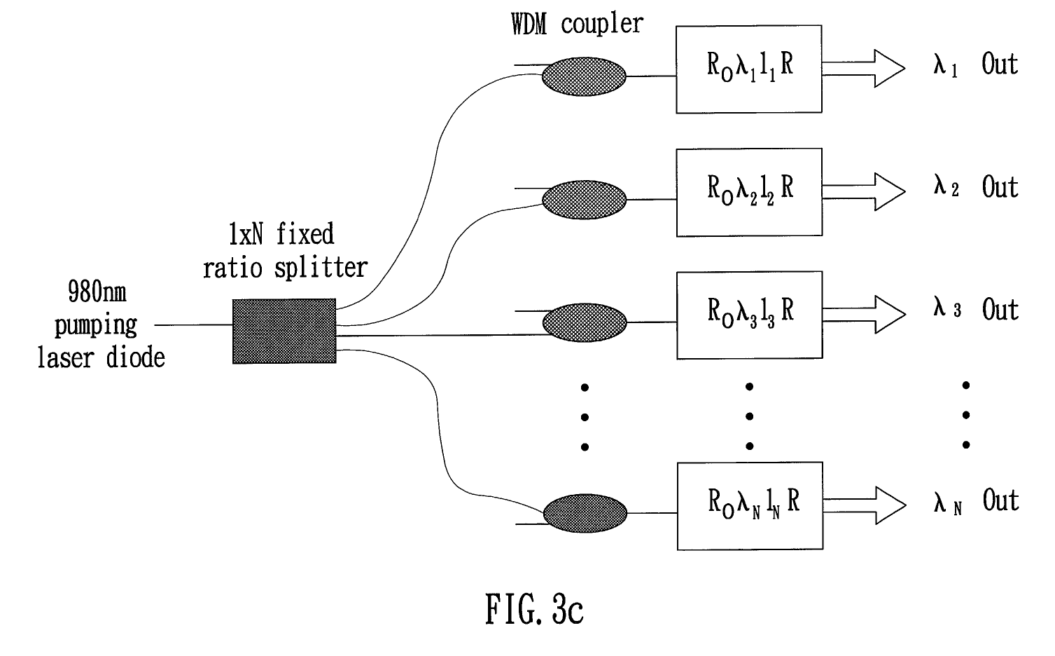

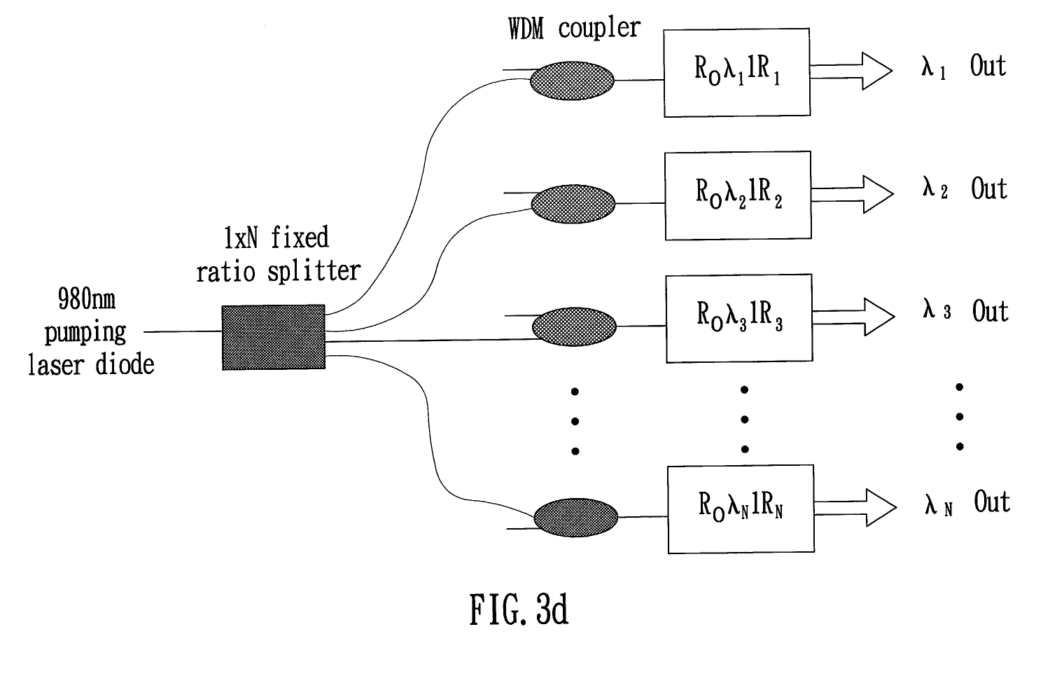

(1) Parallel-type pump-shared method: The parallel-type pumping source distribution architecture is shown in FIGS. 3(a), (b), (c), or (d), which, in addition to resonance cavities, comprises a fixed pump ratio splitter integrated with N optical attenuators, or a 1×N variable ratio splitter to distribute the pumping power to the N-channel fiber lasers.

(2) Wavelength-division multiplexing laser source power-equalizing control method:

(a) Variable optical attenuators controlling methods: a 1×N fixed ratio splitter combined with N variable optical attenuators are added in the N channels.

(b) Pumping power ratio adjustment method: a 1×N variable ratio splitter is added in.

(c) Adjusting the length of EDF or Er³⁺ doping concentration of the gain fiber in the individual resonance cavity.

(d) Adjusting the reflectivity of the grating reflectors.

Under this architecture, the pumping source can be a 980 nm, a 1480 nm, or other appropriate pumping light source.

A parallel-type, pump-shared power-equalizing fiber laser array architecture is proposed in the present invention. The architecture can comprise a plurality of parallel-connected fiber lasers. For solving the problem of unequal power, four kinds of methods are proposed. The EDF can be pumped by a single 980 nm or 1480 nm pumping laser. This module has the advantages of small volume and low price. Manifold selection of light source can thus be provided in the WDM fiber optic transmission system.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A reverse calculation method, wherein the unmodified output result of multi-channel sources are first found out with unequal power, and the pumping power ratio, the EDF length, the Er³⁺ concentration, or the grating reflectivity is then adjusted one by one to equalize the powers among channels.

2. A power-equalizing multi-channel fiber laser array comprising a pumping laser source, 1×N variable ratio splitter, a power-equalizing device (which may include N variable optical attenuators or nothing), a plurality of VDM couplers, a plurality of erbium-doped fibers, and a plurality of pairs of fiber gratings, laser light of said pumping source being split by said 1×N ratio splitter and then coupled to said WDM couplers, each resonance cavity including a pair of fiber gratings and a piece of erbium-doped fiber;
whereby multi-channel light sources can be obtained, and said power-equalizing device or cavity parameters can be used to equalize said multi-channel light sources.

3. The power-equalizing multi-channel fiber laser array as claimed in claim 1, wherein said power-equalizing device consists of a plurality of optical variable attenuators and a 1×N fixed ratio splitter.

4. The power-equalizing multi-channel fiber laser array as claimed in claim 1, wherein said power-equalization is realized by using a 1×N variable ratio splitter.

5. The power-equalizing multi-channel fiber laser array as claimed in claim 1, wherein said power-equalization is realized by adjusting the lengths of said erbium-doped fiber in individual resonance cavity.

6. The power-equalizing multi-channel fiber laser array as claimed in claim 1, wherein said power-equalization is realized by adjusting the concentration of Er³⁺ in the erbium-doped fiber.

7. The power-equalizing multi-channel fiber laser array as claimed in claim 1, wherein said power-equalization is realized by adjusting the reflectivity of said grating reflectors.

8. The power-equalizing multi-channel fiber laser array as claimed in claim 1, wherein the wavelength of said pumping laser source is 980 nm.

9. The power-equalizing multi-channel fiber laser array as claimed in claim 1, wherein the wavelength of said pumping laser source is 1480 nm.
